(19) United States
(12) Patent Application Publication
(10) Pub. No.: US 2020/0173497 A1
(43) Pub. Date: Jun. 4, 2020

(54) Journal Cross and Universal Joint Comprising the Same

(71) Applicant: Off-Highway Powertrain Services Germany GmbH, Lohmar (DE)

(72) Inventors: Timur Mehmet Kisla, Troisdorf (DE); Max Krüger, Lohmar (DE)

(21) Appl. No.: 16/697,470

(22) Filed: Nov. 27, 2019

(30) Foreign Application Priority Data
Nov. 29, 2018 (DE) 102018220609.0

(51) Int. Cl. F16D 3/38

(52) U.S. Cl. CPC F16D 3/38; F16D 2300/18; F16C 2361/41

(57) ABSTRACT

The present invention relates to the field of drive technology and provides a space-saving possibility for determining forces or torques transmitted by a drive shaft with a journal cross of a universal joint with four journals projecting from a base, to which a strain sensor is attached for this purpose.

### CROSS-REFERENCE TO RELATED APPLICATION

This application claims priority to German Patent Application No. 102018220609.0 filed Nov. 29, 2018, the disclosure of which is hereby incorporated by reference in its entirety.

### BACKGROUND OF THE INVENTION

### Field of the Invention

This invention relates to the field of drive technology.

### Description of Related Art

Drive shafts are used to transmit torque in a kinked shaft train. Occasionally, these drive shafts are equipped with an additional length compensation which is also referred to as a slider.

Said drive shafts, which are to be improved with the present invention, are also used between tractors and agricultural machines towed, pushed or carried by them. Between the tractor and the driven machine, a drive shaft with two universal joints and an intermediate, multi-part shaft, which realizes a shaft tube as well as segments for length compensation, is normally used in order to allow torque transmission to be independent of the type of movement performed by the working machines relative to the tractor or towing vehicle. The present invention is particularly concerned with the improvement of such drive shafts.

It is known to measure the transmitted torque between the two universal joints in the area of the shaft, compare DE 101 60 760 B4, DE 10 2013 212 052, WO 2008/138369. For this purpose, a strain gauge is usually attached directly to the shaft tube of the shaft. The transmitted torque is inferred from the strain of the shaft tube. The evaluation of this measurement can be carried out with different objectives. Torque measurement can be used to prevent the components in the drive train or the machines connected to it on the output side from being overloaded.

A sufficiently precise and simple conversion of the torsion-induced strain of the strain gauge into a torque value requires an arrangement of the strain gauge on a cylindrical rotationally symmetric solid body or on a cylindrical rotationally symmetric hollow body. In order to avoid disturbances, the position of the strain gauge should be sufficiently remote from a flange which can be provided to connect the shaft at its end. A further disturbance is an internal and external gearing in the area of the strain gauge which, for example, is configured as part of the length compensation. Occasionally, the drive shafts may only have a short axial extension, which further complicates the appropriate positioning of the strain gauge for the exact determination of the shaft torsion and thus the torque measurement.

### SUMMARY OF THE INVENTION

In order to remedy the aforementioned problems in whole or in part, the present invention suggests a journal cross of a universal joint with four journals projecting from a base, to which at least one strain sensor is attached. Such a strain sensor may be formed by or have a strain measuring sensor element.

The present invention is guided by the idea that the mechanical stress of a drive shaft should not be measured on a shaft body of the drive shaft, but rather in the area of the journal cross. If the geometric conditions and the strain due to a bend in the area of the journal cross are taken into account appropriately, measured values can also be generated in the journal cross with which the mechanical stress of the drive shaft can be calculated or estimated with sufficient accuracy.

The journal cross is the component of a universal joint on which the two fork-shaped actuators of a classic universal joint engage. The journal cross has four journals projecting from the base for pivoting mounting of the actuators and for transmitting the torque from the input side to the output side in the area of the universal joint. The journals and the base are usually configured as a uniform body. The journal cross is usually made of metal and is a cast and/or forged part. The journals are regularly machined to accommodate bearings. However, the journal cross according to the invention can also be made of plastic, for example as a uniform injection-molded part. The implementation of the invention is not restricted to any particular material composition of the journal cross.

According to a preferred further configuration of the present invention, the strain sensor is attached to the base. The strain sensor is preferably applied to the surface of the base. The strain sensor is preferably connected to the base in a material-locking manner.

According to another preferred further configuration of the present invention, the strain sensor comprises at least one sensor element attached to the base between adjacent journals. This sensor element is preferably located in a plane that also contains the four journals. The sensor element is regularly located in a plane containing the central longitudinal axes of the journals.

Thus, the sensor element is usually located in the axial extension direction at the middle height of the journal cross. In configurations in which the diametrically opposed journals each lie on one plane, however, the journals provided between them lie with their central longitudinal axes on a different plane, wherein the planes of the central longitudinal axes are parallel to each other to the two pairs of journals, it is advisable to position the sensor element centrally between the two aforementioned planes.

As far as it is generally referred to the axial extension, this axial extension refers to the axial extension of the linearly running drive shaft. This extension direction is perpendicular to the plane containing the central longitudinal axes of the journals and usually intersects the center of the journals regularly symmetrically formed.

As far as the following description refers to a plane containing the journals, this refers in particular to the plane containing the central longitudinal axis of the four journals.

According to the present invention, the strain sensor has a sensor element that measures the strain by bending the journal relative to the base. In a first variant, it is the bending of the journal in a plane containing the journal. This bending of the journal varies with the torque transmitted by the drive shaft. This configuration of the strain sensor is thus particularly suitable for measuring the torque currently transmitted by the drive shaft.

In another variant, the bending of the journal is the bending transverse to the plane containing the journal. The journal undergoes such a bend by an axial load on the universal joint, thus, the force transmitted in the axial direction. Monitoring the axial load helps to determine premature failure of the journal cross.

It is understood that the journal cross can have both a sensor to measure the bending of the journal relative to the base in a plane containing the journal and a strain sensor to measure the bending of the journal transverse to said plane. Thus, both the axial load and the transmitted torque can be measured via the journal cross. The two sensor elements measuring the corresponding bends can be assigned to one single journal to measure its bend relative to the base. Only one sensor element may also be provided per journal, wherein at least one of the journals may be assigned a sensor element measuring the strain by bending in a plane containing the journals and another journal may be assigned a sensor element measuring the bending of the journal transverse to the plane containing the journals. The journal cross of the present invention can have one or two sensor elements between each journal, thus, a total of four or eight sensor elements.

According to a preferred further configuration at least one sensor element is provided for each journal. The arrangement of the respective sensor elements according to a Wheatstone measuring bridge offers the possibility of eliminating disturbances so that the evaluation of the measuring signals emitted by the sensor elements can be evaluated directly as a measure of the mechanical stress by the transmission of the torque or the transmission of an axially acting force. Thus, for example, strain is directly eliminated by the Wheatstone measuring bridge solely due to temperature fluctuations to which the entire journal cross is exposed.

### BRIEF DESCRIPTION OF THE DRAWINGS

The present invention is explained in more detail below on the basis of embodiments in conjunction with the drawing. Therein:

FIG. 1: shows a perspective side view of a first embodiment of a universal joint;

FIG. 2: shows a perspective top view of a second embodiment of a universal joint, and

FIG. 3: shows a perspective side view of a journal cross which can be used in the universal joints according to FIG. 1 or 2.

### DETAILED DESCRIPTION

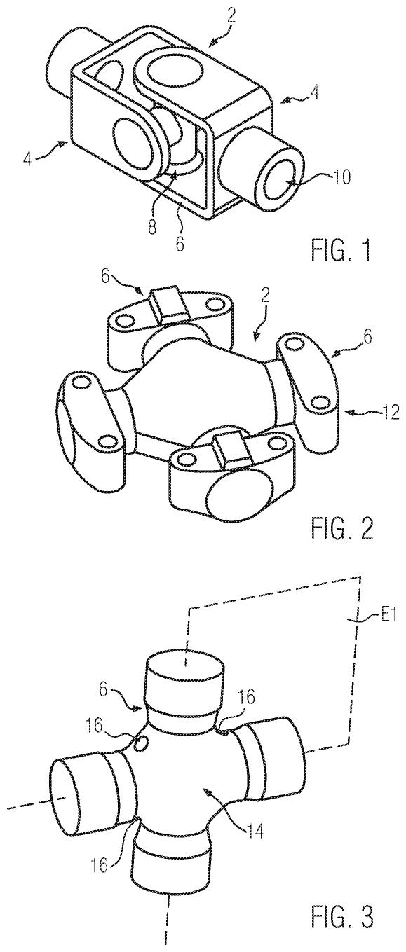

FIG. 1 shows an example of a universal joint 2 with two fork-shaped actuators 4, each of which is pivotally mounted on opposite journals 6 of a journal cross 8. The fork-shaped actuators 4 comprise receptacles 10 for the torque-proof accommodation of a non-shown shaft body.

FIG. 2 shows an alternative example of a universal joint 2 with a journal cross 8, the journal 6 of which each is accommodated in journal receptacles 12, which can be mounted on the drive or output side via non-shown fastening screws. Compared to the embodiment shown in FIG. 1, the embodiment shown in FIG. 2 has a smaller axial structure. Both embodiments can, however, realize the invention explained below with reference to FIG. 3.

FIG. 3 shows an embodiment of a journal cross 8 with four journals 6 defining a plane E1 containing the central longitudinal axes of the journals 6. The journals 6 project from a middle base 14 and are realized with base 14 in a uniform forged component. The surface of base 14 is essentially unfinished. The circumferential surface of the journals 6 is turned down on a lathe to accommodate bearings.

On the outer circumferential surface of the base 14 and between two adjacent journals 6, a sensor element 16 is connected to the base 14 in the plane E1 on a smoothly milled surface of the base 14. This sensor element can be a strain gauge or a piezobased strain sensor.

According to the present invention, the mechanical stress of the journal cross 2 is measured directly at the journal cross 2 in order to deduce the torque transmitted via the universal joint 2 or the drive shaft or the axial force transmitted by these components. For this purpose the sensor element 16 is glued to the base 14 or otherwise connected to it in a material-locking manner. In the embodiment shown, at least one sensor element 16 is provided between each adjacent journal 6.

To determine the transmitted torque, the bending of the journal 6 in the plane E1 containing the journal 6 relative to the base 8 is determined. The degree of bending of the journal 6 in this plane E1 depends on the height of the torque transmitted via the journal cross 8.

Alternatively or additionally, the bending of the journal 6 in relation to the base 14 can be measured at right angles to the plane E1 containing the journal 6. This bending is in turn dependent on the axial force transmitted in the axial direction by a shaft connected via the journal cross 8. The axial direction corresponds to the axis of rotation of the journal cross 8, which penetrates the base 14 at right angles to the plane E1 at the center of the journal cross.

The present invention provides a simple and compact possibility to measure the mechanical stress of a drive shaft or a universal joint of such a shaft by attaching a strain sensor to the journal cross itself. In this way, the mechanical stress within the universal joint can be determined. The drive shaft may be designed solely for the desired application. There is no need to consider any torsional measurement requirements on the shaft when configuring the drive shaft.

The present invention is aware of the fact that mechanical stresses within the journal cross vary depending on the angle of rotation due to the drive shaft error. However, this variance can be eliminated by a logic connected to the strain sensor to evaluate the sensor signal.

The transmission of the sensor signal from the strain sensor is usually contact-free. The strain sensor can be equipped with an autonomous energy source so that wiring between the drive shaft containing the journal cross and a logic for evaluating the sensor signal and/or energizing the sensor can be completely omitted.

### REFERENCE SIGN LIST

2 universal joint
4 fork-shaped actuator
6 journal
8 journal cross
10 receptacle
12 journal
14 base
16 sensor element
E1 plane containing the central longitudinal axes of the journals 6

1. A journal cross of a universal joint with four journals projecting from a base, comprising at least one strain sensor fastened to the journal cross.

2. The journal cross according to claim 1, wherein the strain sensor is fastened to the base.

3. The journal cross according to claim 1, wherein the strain sensor has at least one sensor element fastened to the base between adjacent journals.

4. The journal cross according to claim 1, wherein the strain sensor comprises a sensor element measuring the strain by bending the journal relative to the base in a plane containing the journals.

5. The journal cross according to claim 1, wherein the strain sensor comprises a sensor element measuring the strain by bending the journal relative to the base transversely to a plane containing the journal.

6. The journal cross according to claim 3, wherein at least one sensor element is arranged between each of the journals.

7. The journal cross according to claim 4, wherein at least one sensor element is arranged between each of the journals.

8. The journal cross according to claim 5, wherein at least one sensor element is arranged between each of the journals.

9. A universal joint comprising two fork-shaped actuators which are each pivotally mounted on opposite journals of the journal cross according to claim 1.
